(19) United States
(12) Patent Application Publication
(10) Pub. No.: US 2017/0271820 A1
(43) Pub. Date: Sep. 21, 2017

(54) ELECTRICAL CONNECTOR

(71) Applicant: Molex, LLC, Lisle, IL (US)

(72) Inventor: Yi-Tse HO, Taipei (TW)

(73) Assignee: Molex, LLC, Lisle, IL (US)

(21) Appl. No.: 15/309,644

(22) PCT Filed: May 29, 2015
(86) PCT No.: PCT/IB2015/001211

§ 371 Date: Nov. 8, 2016

(30) Foreign Application Priority Data
May 30, 2014 (CN) 201420288762.1
May 30, 2014 (CN) 201420289128.X

(51) Int. Cl. H01R 13/6585; H01R 24/60; H01R 13/6591

(52) U.S. Cl. CPC H01R 13/6585; H01R 13/6591; H01R 24/60; H01R 2107/00

(57) ABSTRACT

An electrical connector suitable to mate with another mating connector comprises an combined body, a grounding metal plate and an outer shielding shell. The combined body comprises a first terminal module and a second terminal module. The first terminal module has a first insulative piece and a plurality of first terminals. The first insulative piece has a first base portion and a first tongue portion. Each first terminal forms a first mating portion and a first soldering portion. The second terminal module has a second insulative piece assembled with the first insulative piece and a plurality of second terminals. The second insulative piece has a second base portion and a second tongue portion. Each second terminal forms a second mating portion and a second soldering portion. The grounding metal plate is interposed between the first terminal module and the second terminal module. The outer shielding shell surrounds an outer space of the first tongue portion and an outer space of the second tongue portion, and forms a mating cavity for insertion of the mating connector.

### RELATED APPLICATIONS

This application is a national stage application of PCT Application No. PCT/IB2015/001211, filed May 29, 2015, which claims priority to Chinese Application No. 201420289128.X, filed May 30, 2014, and Chinese Application No. 201420288762.1, filed May 30, 2014, all of which are incorporated herein by reference in their entirety.

### TECHNICAL FIELD

The present disclosure relates to an electrical connector, and particularly relates to an electrical connector having a simple configuration and easily assembled.

### BACKGROUND ART

In order to improve qualities of data transmission, power supply and electromagnetic shield of an electrical connector, a plurality of terminals with different functions are often provided on an insulative body of the electrical connector in an conventional electrical connector, and a shielding member is embedded in the insulative body so as to reduce electromagnetic interference during the data transmission of the terminals.

However, when the terminals or the shielding member or the like are added into the electrical connector, typically, complexity of the overall configuration of the electrical connector is significantly increased, for example, Chinese Patent Application No. 201320378153.0 discloses an electrical connector, a plurality of different assembling configurations are required to mold respectively so as to cooperate with a shielding member or the like for assembling, thereby complicating the configuration of the electrical connector, and in turn increasing the manufacture cost. Furthermore, the terminals of the electrical connector are provided on two opposite side surfaces of a tongue of the insulative body, respectively, thereby improving the difficulty of assembling and complicating the configuration and the assembly process. Moreover, the conventional electrical connector cannot fully shield all the electromagnetic radiation, once the electromagnetic radiation passes through the insulative body to leak rearwards, negative effects will be applied on a tail portion of the terminal, thereby decreasing the quality of the signal transmission. Therefore, there is still improved space for the conventional electrical connector.

### SUMMARY

Therefore, an object of the present disclosure is to provide an electrical connector having a simple configuration and easily assembled.

Another object of the present disclosure is to provide an electrical connector with a better electromagnetic shielding effect.

Therefore, an electrical connector of the present disclosure is suitable to mate with another mating connector. In an embodiment, the electrical connector comprises a combined body, a grounding metal plate and an outer shielding shell. The combined body comprises a first terminal module and a second terminal module. The first terminal module has a first insulative piece and a plurality of first terminals fixed to the first insulative piece. The first insulative piece has a first base portion and a first tongue portion extending forwards from the first base portion. The first tongue portion has a first combined surface and a first mating surface opposite to each other. One end of each first terminal extends forwards from the first base portion to form a first mating portion exposed on the first mating surface, and the other end of each first terminal extends outwards from the first base portion to form a first soldering portion.

The second terminal module has a second insulative piece assembled with the first insulative piece and a plurality of second terminals fixed to the second insulative piece. The second insulative piece has a second base portion and a second tongue portion extending forwards from the second base portion. The second tongue portion has a second combined surface facing the first combined surface and a second mating surface opposite to the second combined surface. One end of each second terminal extends forwards from the second base portion to form a second mating portion exposed on the second mating surface, the other end of each second terminal extends outwards from the second base portion to form a second soldering portion. The grounding metal plate is interposed between the first terminal module and the second terminal module. The outer shielding shell surrounds an outer space of the first tongue portion and an outer space of the second tongue portion and forms a mating cavity for insertion of the mating connector.

In an embodiment, the first insulative piece further has at least a first fixing mechanism on the surface facing the second insulative piece; the second insulative piece is provided with a second fixing mechanism cooperating with and fixed to the first fixing mechanism.

In an embodiment, the grounding metal plate is formed with at least a through hole corresponding to the first fixing mechanism and the second fixing mechanism; the first fixing mechanism and the second fixing mechanism are respectively a fixing protruding post and a fixing hole which cooperate with each other, the first fixing mechanism passes through the through hole of the grounding metal plate to engage with the second fixing mechanism.

In an embodiment, two opposite surfaces of the grounding metal plate respectively attach on the first combined surface of the first tongue portion and the second combined surface of the second tongue portion, the grounding metal plate is provided with two mating side edges respectively exposed out of the first tongue portion and the second tongue portion.

In an embodiment, a configuration of the first terminal module and a configuration of the second terminal module are the same, a fixed legs extend respectively from each of the first insulative piece and the second insulative piece.

In an embodiment, the first terminal module is provided above the second terminal module, at least a fixed leg extends downwards from the second base portion of the second insulative piece.

In an embodiment, the electrical connector further comprises an inner shielding shell provided to the combined body; the inner shielding shell is positioned between the outer shielding shell and the first base portion and the second base portion, and covers at least a rear section of the first tongue portion and the second tongue portion.

In an embodiment, the inner shielding shell comprises a fixed section and an extending section, the fixed section abuts against an inner surface of the outer shielding shell and is fixed to the first base portion or the second base portion, the extending section covers the rear section of the first tongue portion and the second tongue portion.

In an embodiment, the inner shielding shell comprises two metal plates respectively attaching on the first insulative piece and the second insulative piece; and each metal plate has a front extending plate attaching on the rear section of the first tongue portion or the rear section of the second tongue portion, a rear extending plate attaching on the corresponding first base portion or the corresponding second base portion and a connecting plate perpendicular to the front extending plate and the rear extending plate.

In an embodiment, a front end of each front extending plate forms a guiding front edge; a gap is formed between each guiding front edge and each combined body to allow the guiding front edge slightly displace toward the combined body.

In an embodiment, two sides of the combined body are further formed with two receiving grooves respectively adjacent to the two sides of the front extending plate; a rear side of each receiving groove has a channel extending vertically and penetrating the first base portion and the second base portion; each metal plate further has two fixed protruding tabs provided at two sides of the corresponding front extending plate; each fixed protruding tab extends from the corresponding front extending plate and extends into the adjacent receiving groove and latches on to the corresponding channel.

In an embodiment, each metal plate further has at least a connecting elastic tab extending away from the combined body; each connecting elastic tab is engaged with the outer shielding shell.

In an embodiment, the electrical connector comprises a combined body, a grounding metal plate, an outer shielding shell and an inner shielding shell. The combined body comprises: an insulative body having a main body and a tongue protruding forwards from the main body, the tongue has an upper surface and a lower surface; and a plurality of terminals divided into an upper row and a lower row and fixed to the insulative body, each terminal has a contact portion extending forwards and exposed out of the tongue and a tail portion extending out of the insulative body, the contact portions of the terminals in the upper row are exposed on the upper surface of the tongue and the contact portions of the terminals in the lower row are exposed on the lower surface of the tongue. The grounding metal plate is fixed in the combined body and is a plate positioned between the terminals in the upper row and the terminals in the lower row. The outer shielding shell engages with the insulative body and surrounds an outer space of the tongue to define a mating cavity. The inner shielding shell is positioned in an inner side of the outer shielding shell and provided on a surface of the combined body, the inner shielding shell has an upper metal plate and a lower metal plate, the upper metal plate has at least a connecting elastic tab extending away from the combined body, the connecting elastic tab is connected to the outer shielding shell.

In an embodiment, the lower metal plate has at least a connecting elastic tab extending away from the combined body, the connecting elastic tabs are connected to the outer shielding shell.

In an embodiment, the lower metal plate has at least a soldering leg extending away from the combined body, the soldering leg extends out of the outer shielding shell and is soldered to the corresponding circuit board for achieving grounding.

In an embodiment, the grounding metal plate comprises a first shielding portion and a second shielding portion extending from the first shielding portion, the first shielding portion is fixed in the insulative body, the second shielding portion and the tail portions of the terminals extend out of the insulative body along the same direction.

In an embodiment, the outer shielding shell has at least a soldering leg to be soldered to the circuit board for achieving grounding.

In an embodiment, the insulative body is assembled by a first insulative piece and a second insulative piece, the terminals in the upper row are embedded in the first insulative piece, the terminals in the lower row are embedded in the second insulative piece, the grounding metal plate is interposed between the first insulative piece and the second insulative piece.

In an embodiment, the first insulative piece comprises a first base portion and a first tongue portion extending forwards from the first base portion, the contact portions of the terminals in the upper row are exposed out of the first tongue portion; the second insulative piece comprises a second base portion and a second tongue portion extending forwards from the second base portion, the contact portions of the terminals in the lower row are exposed out of the second tongue portion; the first tongue portion and the second tongue portion are assembled to form the tongue of the insulative body, the first base portion and the second base portion are assembled to form the main body of the insulative body.

The effects of the present disclosure are as follows: by the design of the first terminal module and the second terminal module, the first terminal and the second terminal may be respectively fixed on a side surface of the first insulative piece and a side surface of the second insulative piece first, and then the first terminal module and the second terminal module are assembled and interpose the grounding metal plate therebetween, thereby decreasing the difficulty of the assembling process. Moreover, the grounding metal plate has the exposed mating side edge and the electrical connector is provided with the inner shielding shell, thereby making the electrical connector achieve a better electromagnetic shielding effect; in addition, the inner shielding shell and the outer shielding shell are connected via the connecting elastic tab, the inner shielding shell may achieve a grounding effect via the outer shielding shell, thereby making the electrical connector achieve a better electromagnetic shielding effect.

### BRIEF DESCRIPTION OF THE DRAWINGS

The foregoing and other features and effects of the embodiments of the present disclosure will be apparent through the embodiments with reference to the Figures, and in Figures:

FIG. 1 is a perspective view illustrating a first embodiment of an electrical connector of the present disclosure;

FIG. 2 is an exploded perspective view illustrating components of the first embodiment of the present disclosure;

FIG. 3 is an exploded perspective view illustrating the components of the first embodiment of the present disclosure viewed from another angle;

FIG. 4 is an exploded perspective view illustrating an assembling relationship between two metal plates of an inner shielding shell;

FIG. 5 is an exploded perspective view illustrating components of an combined body;

FIG. 6 is an exploded perspective view illustrating the components of the combined body viewed from another angle;

FIG. 7 is a front view illustrating a front side of the first embodiment;

FIG. 8 is a cross sectional view taken along a line VIII-VIII of FIG. 7 illustrating an inner portion of the first embodiment;

FIG. 9 is a perspective view illustrating the first embodiment is mated with another mating connector;

FIG. 10 is a perspective view illustrating an electrical connector of a second embodiment of the present disclosure is provided on a circuit board and illustrating a mating relationship between the electrical connector and a plug connector;

FIG. 11 is a perspective view illustrating the second embodiment is provided on a circuit board;

FIG. 12 is an exploded perspective view illustrating an combined relationship between an outer shielding shell and an insulative body of the second embodiment;

FIG. 13 is a view of FIG. 12 viewed from another angle;

FIG. 14 is an exploded perspective view illustrating an combined relationship between an inner shielding shell and the insulative body of the second embodiment;

FIG. 15 is a view of FIG. 14 viewed from another angle;

FIG. 16 is an exploded perspective view illustrating an combined relationship among a grounding metal plate, a soldering leg positioning member and the insulative body of the second embodiment;

FIG. 17 is a view of FIG. 16 viewed from another angle;

FIG. 18 is an exploded perspective view illustrating an combined relationship among terminals and a first insulative piece and a second insulative piece of the insulative body of the second embodiment;

FIG. 19 is a view of FIG. 18 viewed from another angle;

FIG. 20 is a front view illustrating the embodiment;

FIG. 21 is a cross sectional view taken along a line XII-XII of FIG. 20;

FIG. 22 is a cross sectional view taken along a line XIII-XIII of FIG. 20;

FIG. 23 is a perspective view illustrating a functional relationship between a terminal spaced portion and a terminal tail portion of the second embodiment; and

FIG. 24 is a partial view of FIG. 23 illustrating the functional relationship between the terminal spaced portion and the terminal tail portion of the second embodiment.

### DETAILED DESCRIPTION OF THE PREFERRED EMBODIMENTS

The foregoing and other technical contents, features and effects of the present disclosure will be apparent through the following detailed description for two specific embodiments in combination with the Figures.

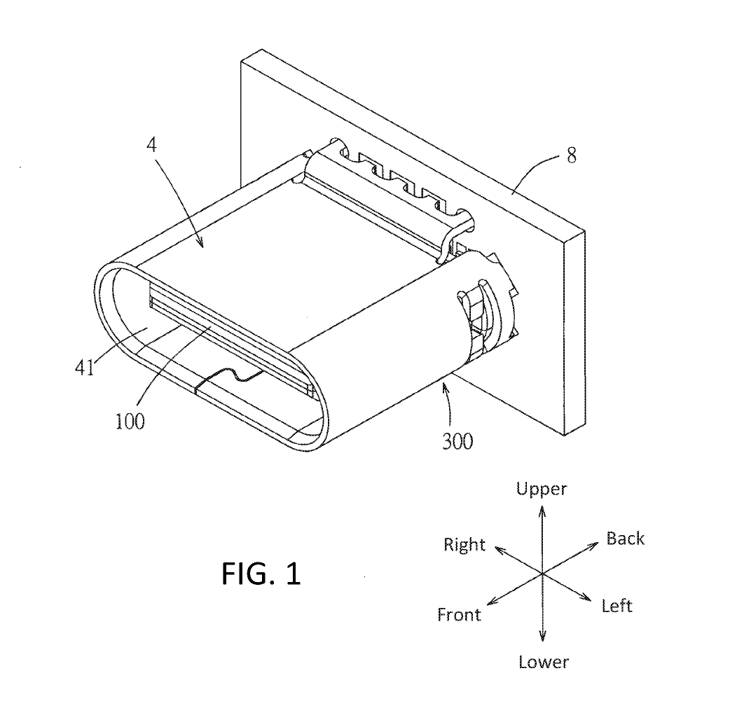

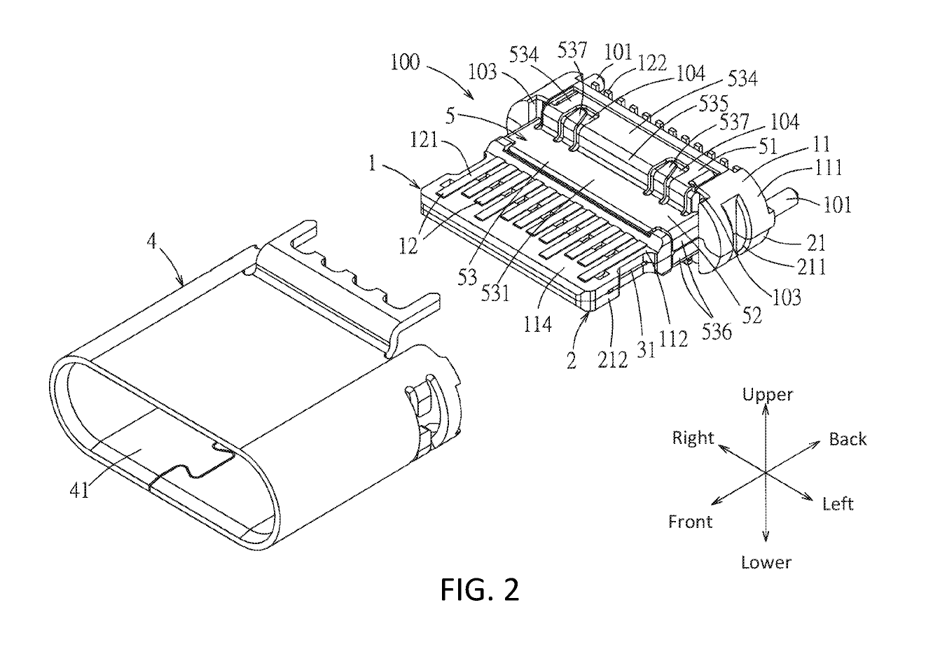

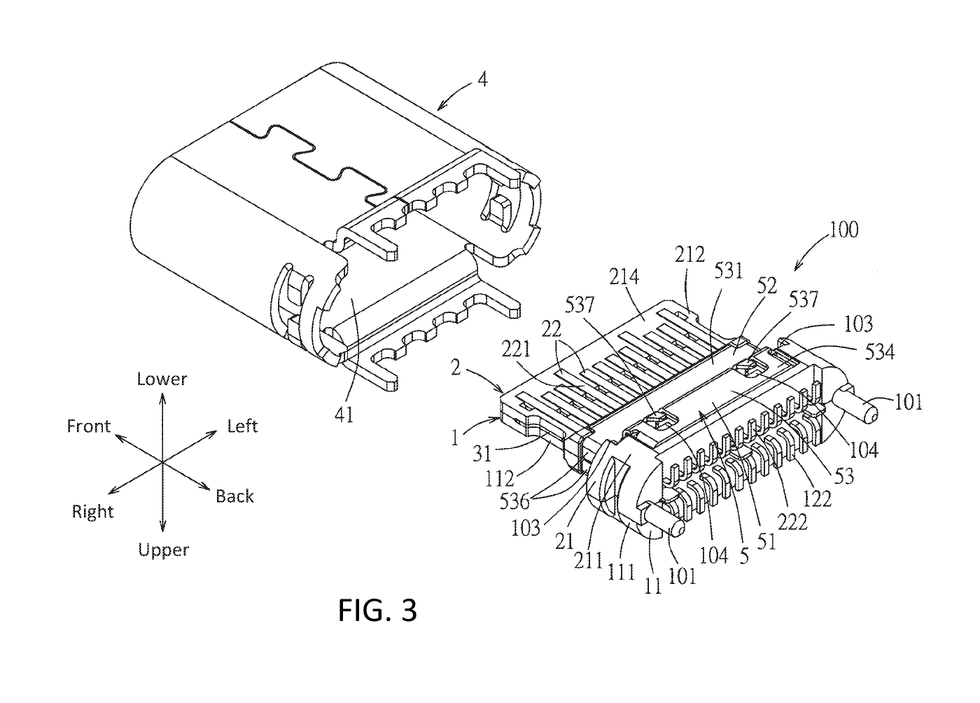

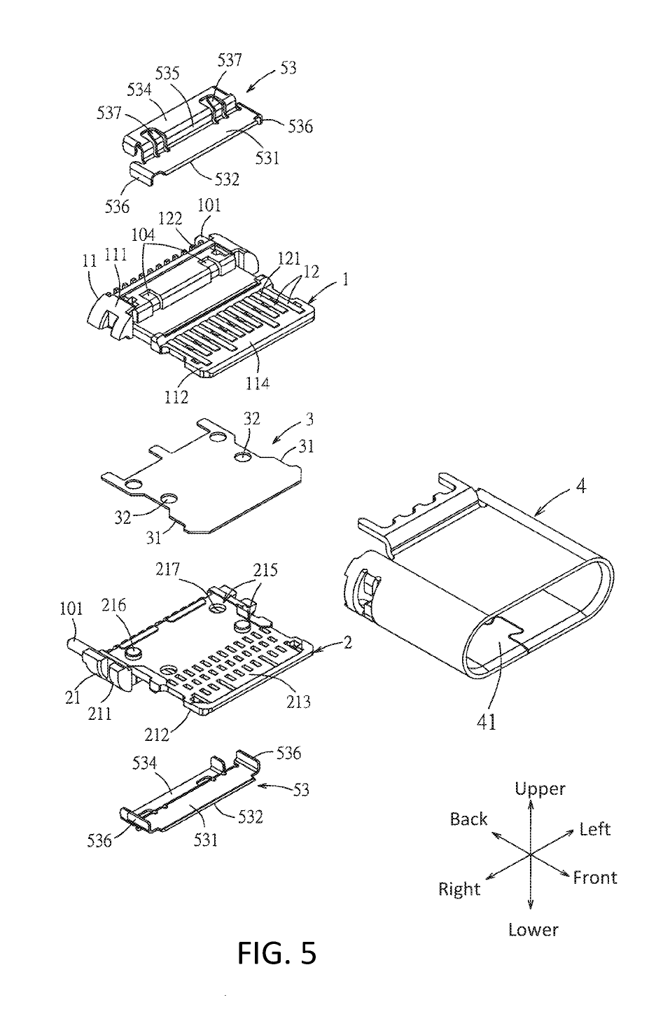

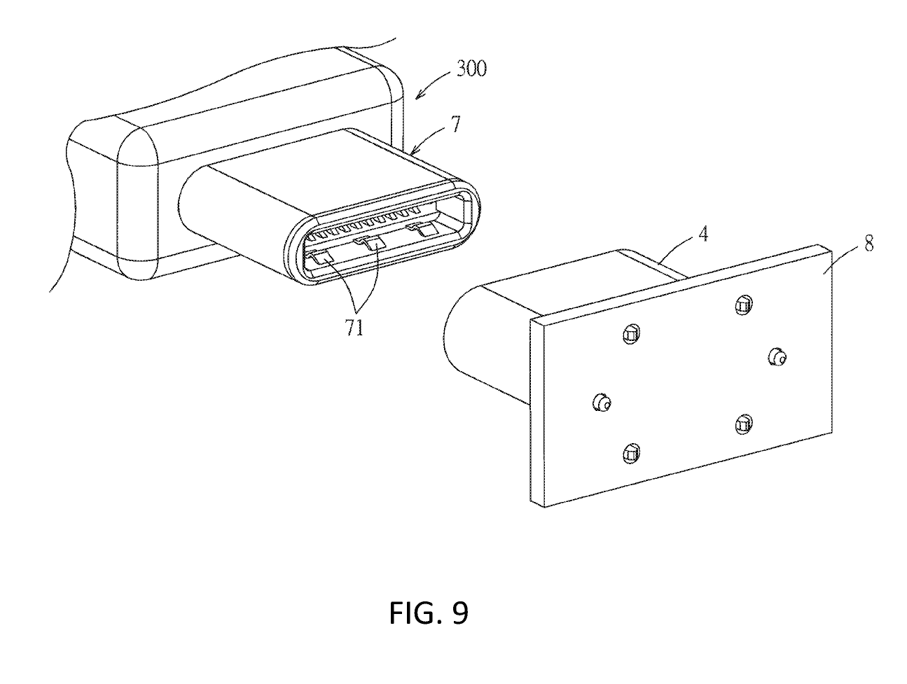

Referring to FIG. 1 to FIG. 3, a first embodiment of an electrical connector of the present disclosure is illustrated. Specifically, the first embodiment is a receptacle connector suitable for insertion and connection of another mating connector 7 (see FIG. 9). The electrical connector 300 comprises an combined body 100, a grounding metal plate 3 fixed in the combined body 100 (see FIG. 5), an outer shielding shell 4 surrounding the combined body 100 and an inner shielding shell 5 positioned in an inner side of the outer shielding shell 4 and provided on a surface of the combined body 100.

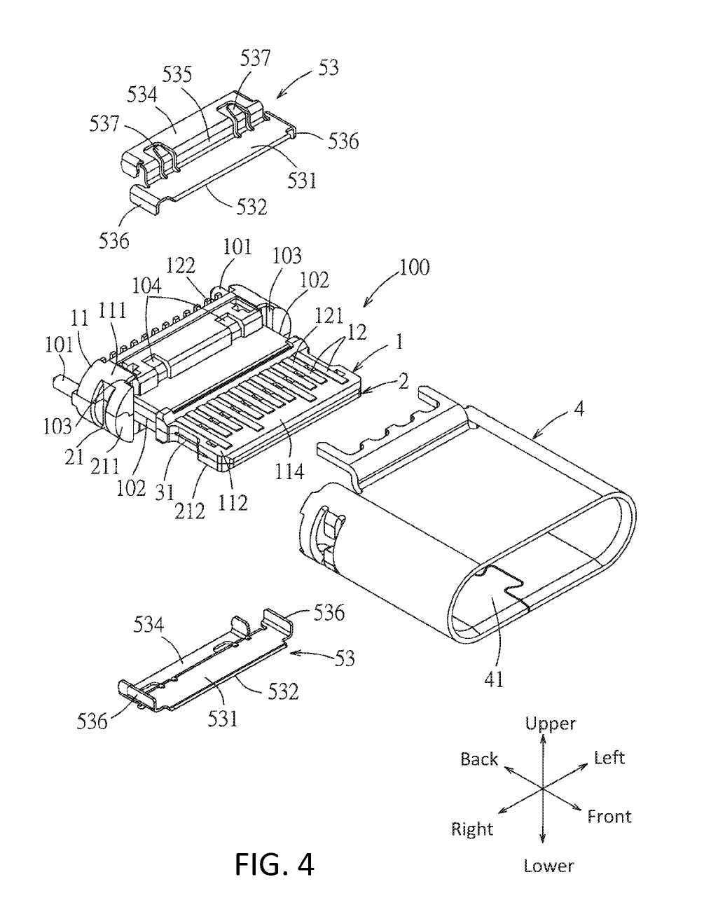

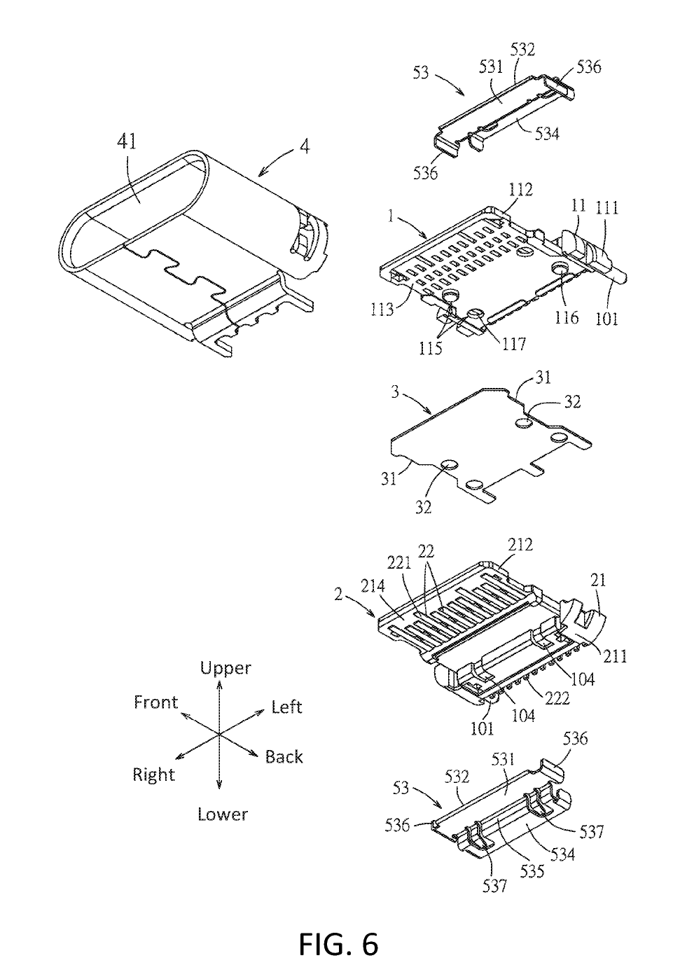

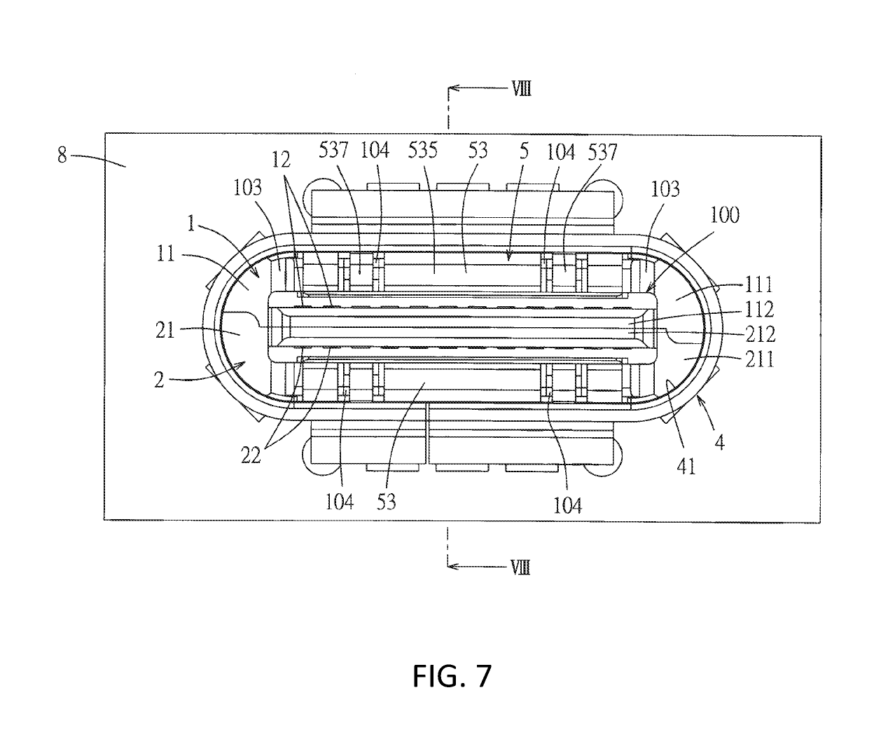

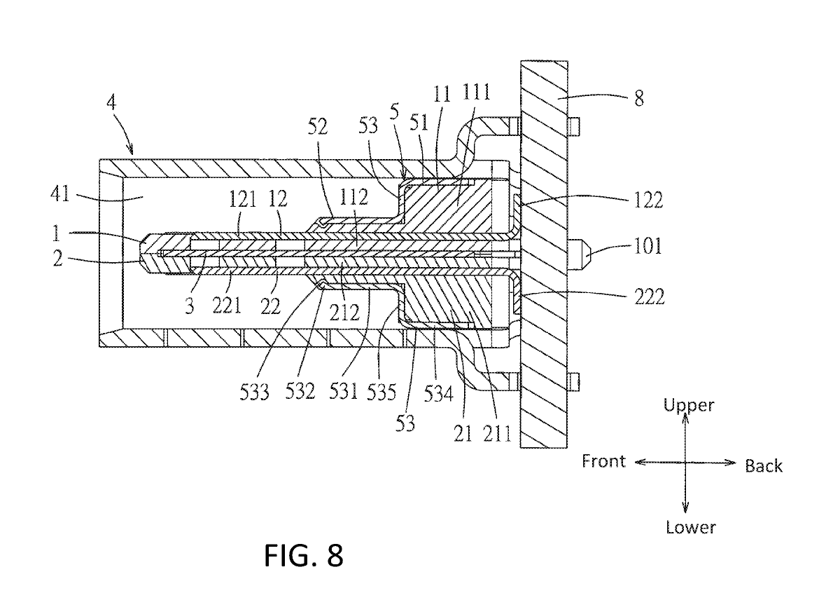

Referring to FIG. 4 to FIG. 6, the combined body 100 comprises a first terminal module 1 and a second terminal module 2 assembled with each other. The first terminal module 1 has a first insulative piece 11 and a plurality of first terminals 12 embedded in the first insulative piece 11. The first insulative piece 11 has a first base portion 111, a first tongue portion 112 extending forwards from a front side of the first base portion 111 and two first fixing mechanisms 115 facing downwards the second terminal module 2. The first tongue portion 112 has a first combined surface 113 facing downwards the second terminal module 2 and a first mating surface 114 opposite to the first combined surface 113. The first terminal 12 is fixed to the first base portion 111, and a front end of the first terminal 12 extends forwards from the first base portion 111 to form a first mating portion 121 exposed on the first mating surface 114, and a rear end of the first terminal 12 extends outwards from the first base portion 111 to form a first soldering portion 122 to be soldered to a circuit board 8 (see FIG. 7 and FIG. 8).

A configuration of the second terminal module 2 is the same as the configuration of the first terminal module 1, and the configuration of the second terminal module 2 and the configuration of the first terminal module 1 are in 180 degrees rotational symmetry. The second terminal module 2 has a second insulative piece 21 assembled upwards to the first insulative piece 11 and a plurality of second terminals 22 embedded in the second insulative piece 21. The second insulative piece 21 has a second base portion 211 corresponding to the first base portion 111 in position, a second tongue portion 212 extending forwards from a front side of the second base portion 211 and corresponding to the first tongue portion 112 in position and two second fixing mechanisms 215 cooperating with and fixed to the first fixing mechanism 115 of the first insulative piece 11. The second tongue portion 212 has a second combined surface 213 facing upwards the first combined surface 113 and a second mating surface 214 opposite to the second combined surface 213. A front end of the second terminal 22 extends forwards from the second base portion 211 to form a second mating portion 221 exposed on the second mating surface 214, a rear end of the second terminal 22 extends outwards from the second base portion 211 to form a second soldering portion 222 to be soldered to the circuit board 8 (see FIG. 7 and FIG. 8).

The combined body 100 further comprises two fixed legs 101 respectively provided at a rear side of the first base portion 111 and a rear side of the second base portion 211, two receiving grooves 102 respectively formed on the left side and the right side of the combined body 100 and respectively adjacent to a rear section of the first tongue portion 112 and a rear section of the second tongue portion 212, and four recessed portions 104 respectively formed on a top surface of the first base portion 111 and a bottom surface of the second base portion 211. The two fixed legs 101 respectively extend from a rear side of the first insulative piece 11 and a rear side of the second insulative piece 21 and extend rearwards far away from the first insulative piece 11 and the second insulative piece 21, pass through and are fixed to the circuit board 8 (see FIG. 7 and FIG. 8).

The grounding metal plate 3 is interposed between the first terminal module 1 and the second terminal module 2, thereby increasing the strength of the configuration of a tongue assembled by the first tongue portion 112 and the second tongue portion 212 and decreasing the crosstalk of high frequency signals between the first terminal 12 and the second terminal 22. Two opposite surfaces of the grounding metal plate 3 respectively attach on the first combined surface 113 of the first tongue portion 112 and the second combined surface 213 of the second tongue portion 212, the grounding metal plate 3 is provided with two mating side edges 31 exposed out of the first tongue portion 112 and the second tongue portion 212 respectively at a left side and a right side and four through holes 32 vertically penetrating the grounding metal plate 3. The four through holes 32 correspond to the two first fixing mechanisms 115 of the first insulative piece 11 and the two second fixing mechanisms 215 of the second insulative piece 21, therefore the two first fixing mechanisms 115 pass through four through holes 32 of the grounding metal plate 3 to fix and engage with the two second fixing mechanisms 215 and position the grounding metal plate 3 at the same time. In a first embodiment, specifically, each first fixing mechanism 115 comprises a fixing protruding post 116 and a fixing hole 117, each second fixing mechanism 215 comprises a fixing protruding post 216 and a fixing hole 217 which respectively cooperates with the fixing hole 117 and the fixing protruding post 116.

The outer shielding shell 4 surrounds an outer space of the first tongue portion 112 and an outer space of the second tongue portion 212 of the combined body 100, and forms a mating cavity 41 for insertion of the mating connector 7. The inner shielding shell 5 is positioned between the outer shielding shell 4 and the first base portion 111 and the second base portion 211, and at least covers the rear section of the first tongue portion 112 and the rear section of the second tongue portion 212, preferably, the inner shielding shell 5 further covers a front surface of the first base portion 111 facing the mating cavity 41 or a front surface of the second base portion 211 facing the mating cavity 41. Preferably, the inner shielding shell 5 has a fixed section 51 fixed to a front section of the first base portion 111 or a front section of the second base portion 211 and abutting against an inner surface of the outer shielding shell 4 and an extending section 52 attaching on and surrounding the rear section of the first tongue portion 112 and the rear section of the second tongue portion 212, thereby preventing electromagnetic radiation from passing through the combined body 100 to leak rearwards. Specifically, in the embodiment, the inner shielding shell 5 has two metal plates 53 assembled with each other. The two metal plates 53 are respectively positioned at an upper side and a lower side of the combined body 100 to respectively attach on and be fixed to the first insulative piece 11 and the second insulative piece 21.

Each metal plate 53 is substantially a step-shape, and has a front extending plate 531 horizontally attaching on the rear section of the first tongue portion 112 or the rear section of the second tongue portion 212, a rear extending plate 534 horizontally attaching on the front section of the first base portion 111 or the front section of the second base portion 211, a connecting plate 535 connecting the front extending plate 531 and the rear extending plate 534 and extending vertically, two fixed protruding tabs 536 provided at a left side and a right side of the front extending plate 531 and two connecting elastic tabs 537 extending away from the combined body 100. A front end of each front extending plate 531 forms a guiding front edge 532, a gap 533 is formed between each guiding front edge 532 and the combined body 100 (see FIG. 7 and FIG. 8), therefore the guiding front edge 532 may slightly displace toward the combined body 100 when the mating connector 7 is inserted into the mating cavity 41, which facilitates the insertion of the mating connector 7. The two receiving grooves 102 positioned at the left side and the right side of the combined body 100 are respectively adjacent to a left side and a right side of each front extending plate 531, and a rear side of each receiving groove 102 has a channel 103 extending vertically and penetrating the first base portion 111 and the second base portion 211. Each fixed protruding tab 536 extends from the corresponding front extending plate 531 and extends into the adjacent receiving groove 102, and latches on to the corresponding channel 103 to engage with the combined body 100. Each connecting elastic tab 537 is correspondingly received in the recessed portion 104, and an end of each connecting elastic tab 537 is elastically engaged with the outer shielding shell 4, thereby making the inner shielding shell 5 grounded via the outer shielding shell 4 for achieving a grounding effect.

When the electrical connector 300 of the present disclosure is mated with the mating connector 7, each shielding configuration is able to produce a plurality of grounding circuits so as to improve the electromagnetic shielding effect. More specifically, the grounding metal plate 3 not only connects the circuit board 8 positioned at a rear side of the grounding metal plate 3 to form a grounding circuit, but also connects metal elastic arms (not shown) of an outer shell of the mating connector 7 via the mating side edges 31 exposed at the left side and the right side of the grounding metal plate 3, thereby forming another grounding circuit to provide a grounding function for the mating connector 7. Furthermore, the inner shielding shell 5 connects the outer shielding shell 4 via the connecting elastic tabs 537 to form a grounding circuit, and connects grounding elastic tabs 71 (see FIG. 9) of the mating connector 7 to form another grounding circuit when the mating connector 7 is inserted, thereby further improving the electromagnetic shielding effect of the inner shielding shell 5 and the outer shielding shell 4.

It should be emphatically noted that, as the configuration of the first terminal module 1 and the configuration of the second terminal module 2 in the first embodiment are completely the same, the different assembling configurations are not needed to be molded separately, and the first terminal module 1 and the second terminal module 2 are assembled and interpose the grounding metal plate 3 as long as only one type of terminal module is needed, thereby significantly simplifying the complexity of the molding process and the whole configuration. Moreover, the first terminal 12 and the second terminal 22 can be respectively embedded on a side surface of the first insulative piece 11 and a side surface of the second insulative piece 21 first and then assembled, thereby decreasing the difficulty of the assembling process and the complexity of an assembling device. Also, as the configuration of the first terminal 12 of the first terminal module 1 and the configuration of the second terminal 22 of the second terminal module 2 are completely the same and in 180 degrees rotational symmetry, the corresponding mating connector 7 may be properly engaged with the terminals of the electrical connector whether the mating connector 7 is inserted into the electrical connector 300 with a proper orientation or with an upside down orientation

In conclusion, by the design of the first terminal module 1 and the second terminal module 2, the first terminal 12 and the second terminal 22 may be respectively embedded in a side surface of the first insulative piece 11 and a side surface of the second insulative piece 21 first, and then the first terminal module 1 and the second terminal module 2 are assembled and interpose the grounding metal plate 3 therebetween, thereby decreasing the difficulty of the assembling process and the complexity of the assembling device. Moreover, by that the grounding metal plate 3 is provided between the first terminal 12 and the second terminal 22 and the inner shielding shell 5 is positioned at the rear portion of the combined body 100 and the outer shielding shell 4 surrounds the first tongue portion 112 and the second tongue portion 212, the electromagnetic shielding configuration of the electrical connector 300 forms a plurality of grounding circuits and forms an entire shielding configuration, so as to attain a better electromagnetic shielding effect. And the object of the present disclosure is indeed achieved.

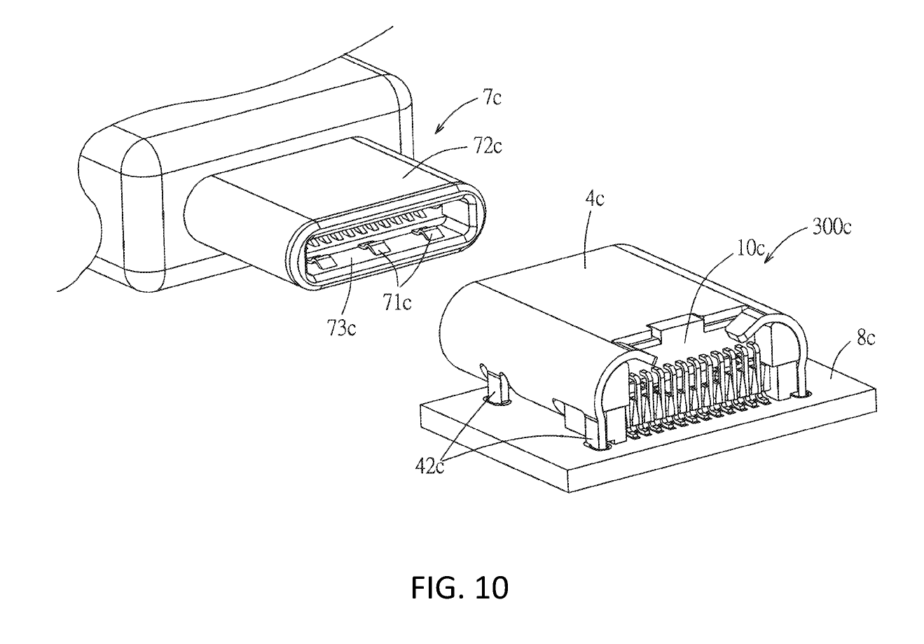

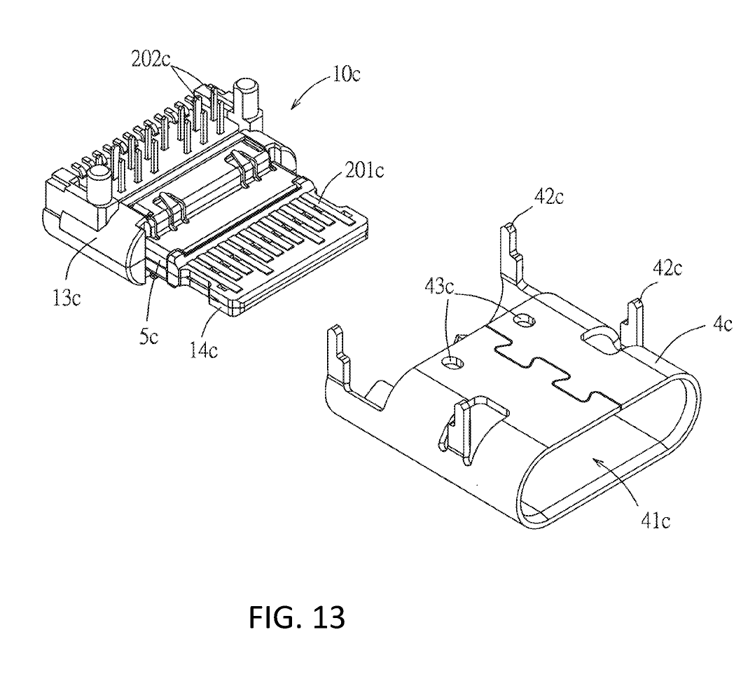

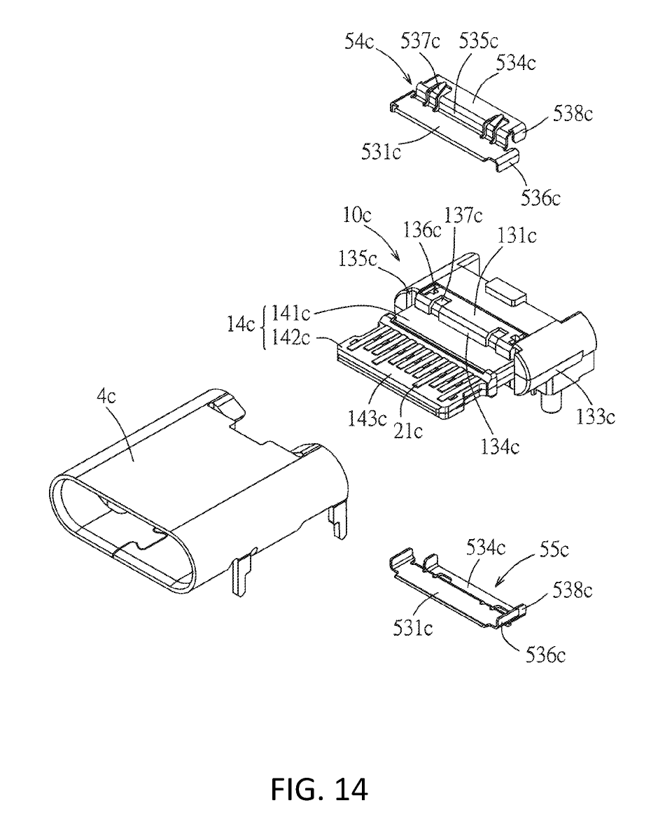

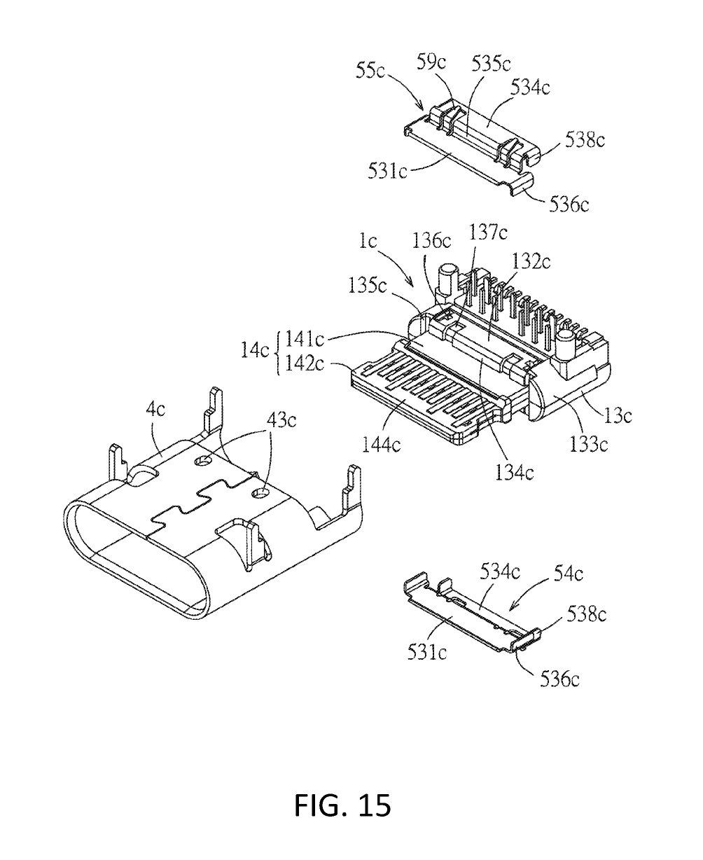

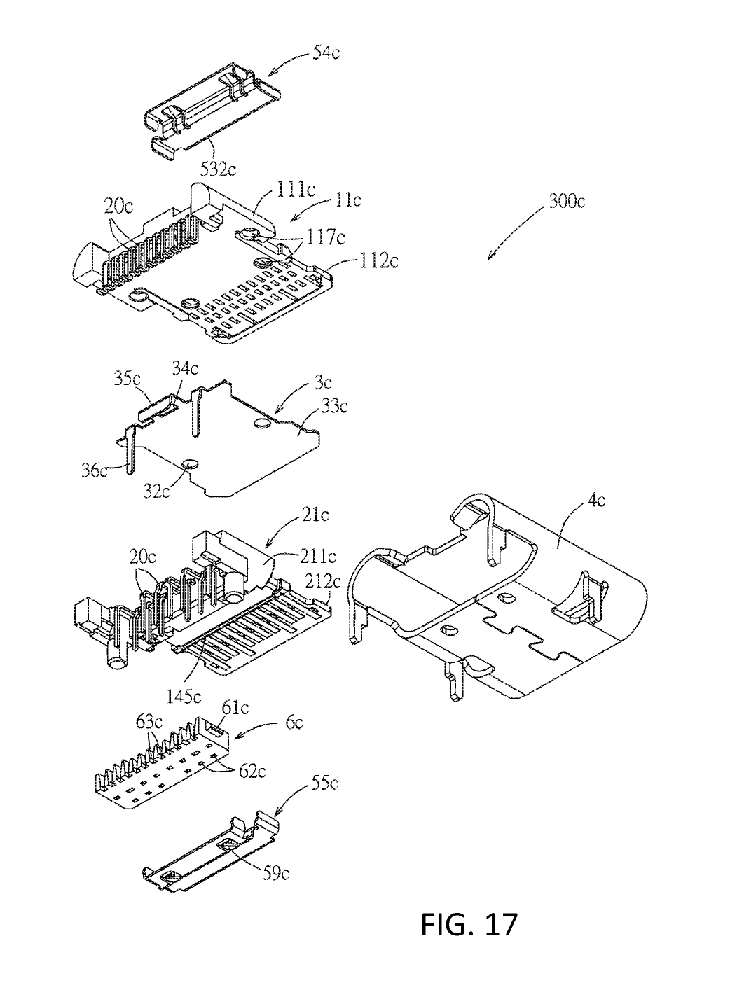

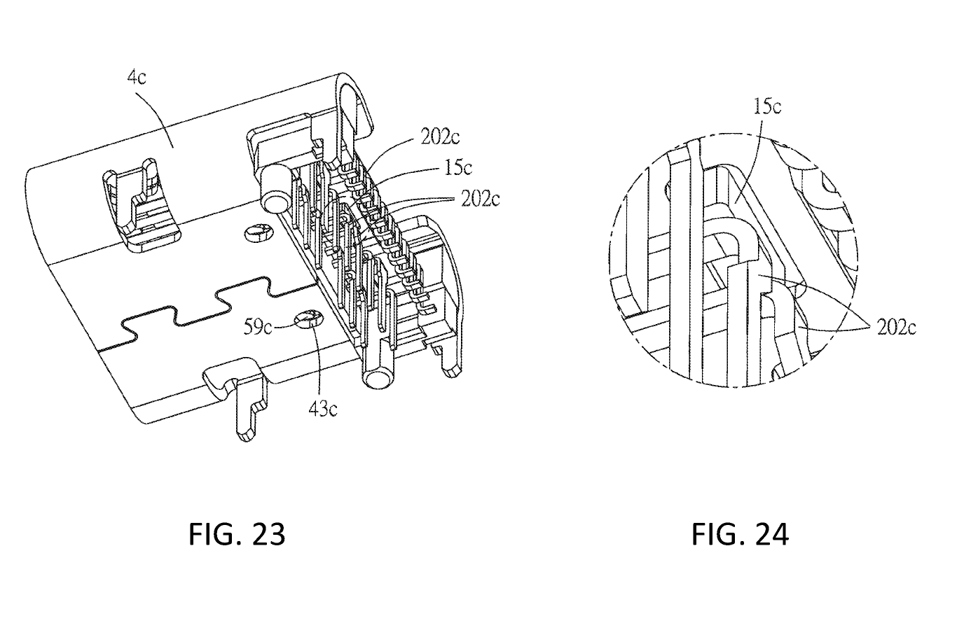

Referring to FIG. 10 to FIG. 24, a second embodiment of the electrical connector of the present disclosure is provided. The electrical connector 300c is a right angle connector.

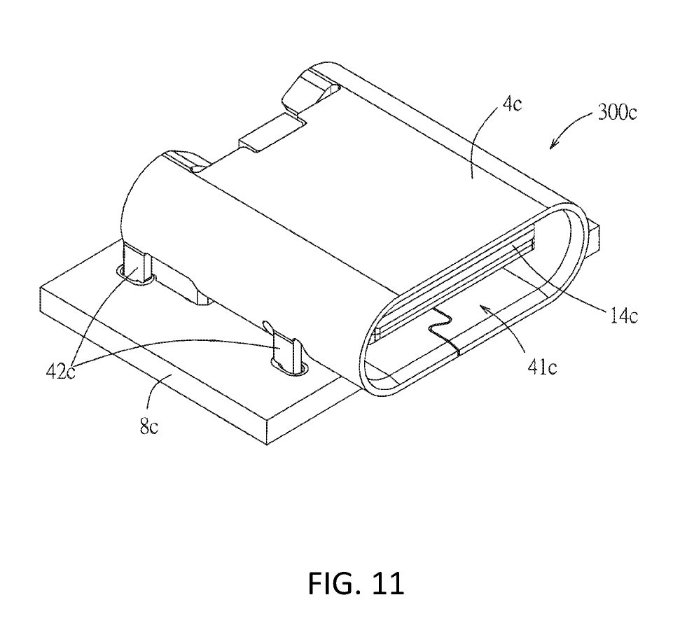

Referring to FIG. 10 and FIG. 11, the electrical connector 300c may be provided to a circuit board 8c for matting of a mating connector 7c.

Referring to FIG. 11 to FIG. 17, the electrical connector 300c comprises an insulative body 10c, a plurality of terminals 20c, an outer shielding shell 4c, an inner shielding shell 5c, a grounding metal plate 3c and a soldering leg positioning member 6c.

The insulative body 10c is assembled by a first insulative piece 11c and a second insulative piece 21c, and has a main body 13c and a tongue 14c protruding forwards from the main body 13c. The main body 13c has a wider upper surface 131c, a wider lower surface 132c, two side surfaces 133c and a front surface 134c connecting the upper surface 131c and the lower surface 132c. The tongue 14c has a base portion 141c connected to the main body 13c and an extending portion 142c extending forwards from the base portion 141c. A thickness of the base portion 141c of the tongue 14c is larger than a thickness of the extending portion 142c of the tongue 14c. Specifically, in the second embodiment, the first insulative piece 11c comprises a first base portion 111c and a first tongue portion 112c extending forwards from the first base portion 111c; the second insulative piece 21c comprises a second base portion 211c and a second tongue portion 212c extending forwards from the second base portion 211c; the first tongue portion 112c and the second tongue portion 212c are assembled to form the tongue 14c of the insulative body 10c, the first base portion 111c and the second base portion 211c are assembled to form the main body 13c of the insulative body 10c.

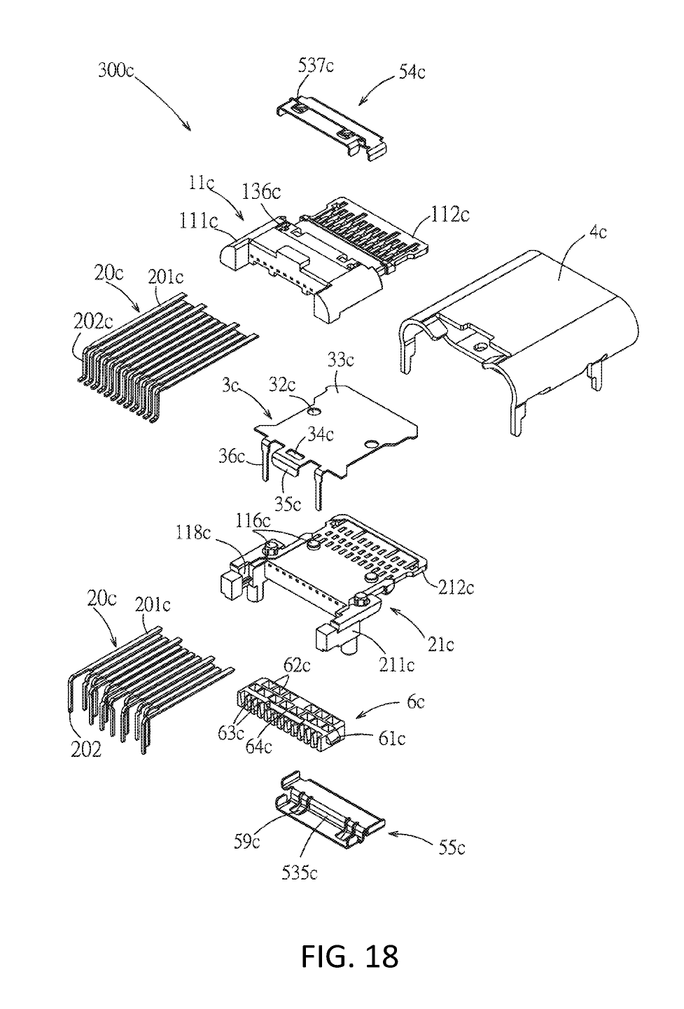

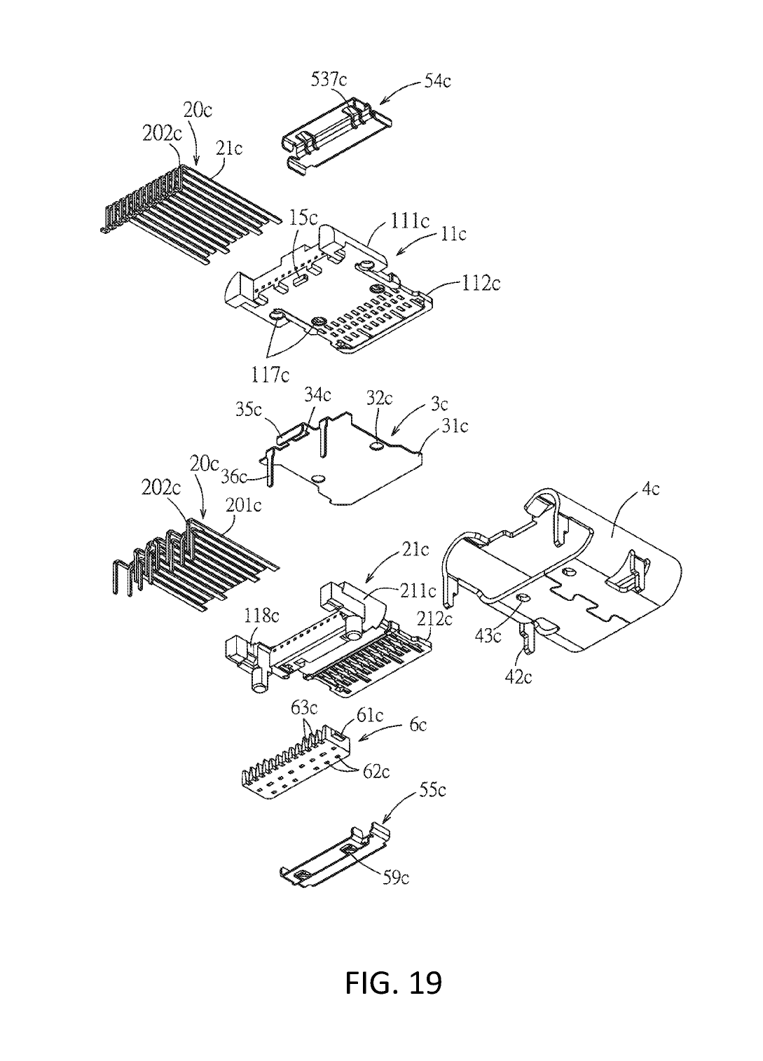

In combination with referring to FIG. 18 and FIG. 19, the terminals 20c are fixed at the insulative body 10c and each terminal 20c has a contact portion 201c exposed out of the extending portion 142c of the tongue 14c, and a tail portion 202c extending rearwards out of the main body 13c of the insulative body 10c. The contact portions 201c of the terminals 20c in an upper row are exposes on an upper surface 143c of the extending portion 142c of the tongue 14c, the contact portions 201c of the terminals 20c in a lower row are exposed on a lower surface 144c of the extending portion 142c of the tongue 14c. In particular, the terminals 20c are divided into the upper row and the lower row, the terminals 20c in the upper row are embedded in the first insulative piece 11c, the terminals 20c in the lower row are embedded in the second insulative piece 21c. The contact portions 201c of the terminals 20c in the upper row are exposed out of the first tongue portion 112c, and the tail portions 202c of the terminals 20c in the upper row extend rearwards out of the first base portion 111c; the contact portions 201c of the terminals 20c in the lower row are exposed out of the second tongue portion 212c, and the tail portions 202c of the terminals 20c in the lower row extend rearwards out of the second base portion 211c. Terminals 20c in each row comprise four terminals 20c protruding forwards and eight terminals 20c positioned rearwards relative to the four terminals 20c. In the four terminals 20c protruding forwards, two longer terminals 20c positioned on the two sides are used for grounding, two longer terminals 20c positioned in the middle are used to provide power. The eight shorter terminals 20c comprise two high speed differential signal pairs, a low speed differential signal pair positioned in the center and two controlling terminals. The contact portions 201c of the terminals 20c in the upper row and the contact portions 201c of the terminals 20c in the lower row are in 180 degrees symmetry relative to the tongue 14c, thereby making the mating connector 7c reversed by 180 degrees and inserted into the electrical connector 300c.

It should be understood that, an assembled configuration of the insulative body 10c and the terminal 20c is equivalent to the combined body 100 of the first embodiment. An assembled configuration of the terminals 20c in the upper row and the first insulative piece 11c is equivalent to the first terminal module 1 of the first embodiment; an assembled configuration of the terminals 20c in the lower row and the second insulative piece 21c is equivalent to the second terminal module 2 of the first embodiment.

The outer shielding shell 4c is combined with the insulative body 10c and surrounds an outer space of the tongue 14c to define a mating cavity 41c, and has four soldering legs 42c to be fixed to the circuit board 8c. A front surface 134c of the insulative body 10c faces the mating cavity 41c.

The inner shielding shell 5c covers the base portion 141c of the tongue 14c and the upper surface 131c, the lower surface 132c and the front surface 134c of the main body 13c, and has a plurality of fixed protruding tabs 536c, 538c for positioning the inner shielding shell 5c. Specifically, the inner shielding shell 5c comprises a first metal plate 54c and a second metal plate 55c. The first metal plate 54c has a front extending plate 531c covering the base portion 141c, a connecting plate 535c vertically bent from a rear end of the front extending plate 531c and extending, and a rear extending plate 534c extending horizontally and rearwards from an upper edge of the connecting plate 535c. The second metal plate 55c has a front extending plate 531c covering the base portion 141c, a connecting plate 535c vertically bent from a rear end of the front extending plate 531c and extending, and a rear extending plate 534c extending horizontally and rearwards from a lower edge of the connecting plate 535c. The two front extending plates 531c respectively cover an upper side and a lower side of the base portion 141c of the tongue 14c, the two connecting plates 535c cover the front surface 134c of the main body 13c, the two rear extending plates 534c respectively cover the upper surface 131c and the lower surface 132c of the main body 13c. In other words, the first metal plate 54c and the second metal plate 55c together cover the upper side and the lower side of the base portion 141c of the tongue 14c, that is, the inner shielding shell 5c covers the base portion 141c of the tongue 14c, so as to surround the terminals 20c therein, and there is a gap between the inner shielding shell 5c and each terminal 20c. In some simplified embodiments (not shown), the inner shielding shell 5c may also be provided to only cover the base portion 141c of the tongue 14c, or only cover the base portion 141c of the tongue 14c and the front surface 134c of the main body 13c, thereby achieving the ground shielding effect to some extent and preventing the electromagnetic radiation in the mating cavity 41c from passing through the insulative body 10c to leak rearwards and affecting the tail portion 202c of the terminal 20c, therefore an object of improving the quality of the signal transmission of the terminals 20c and preventing the electromagnetic radiation from leaking to the outside of the electrical connector 300c is achieved.

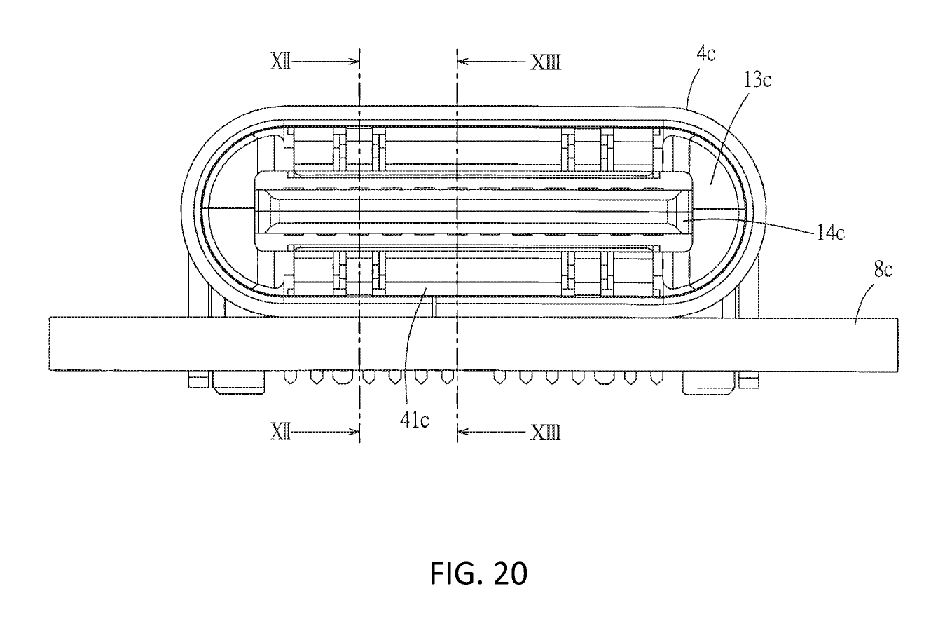

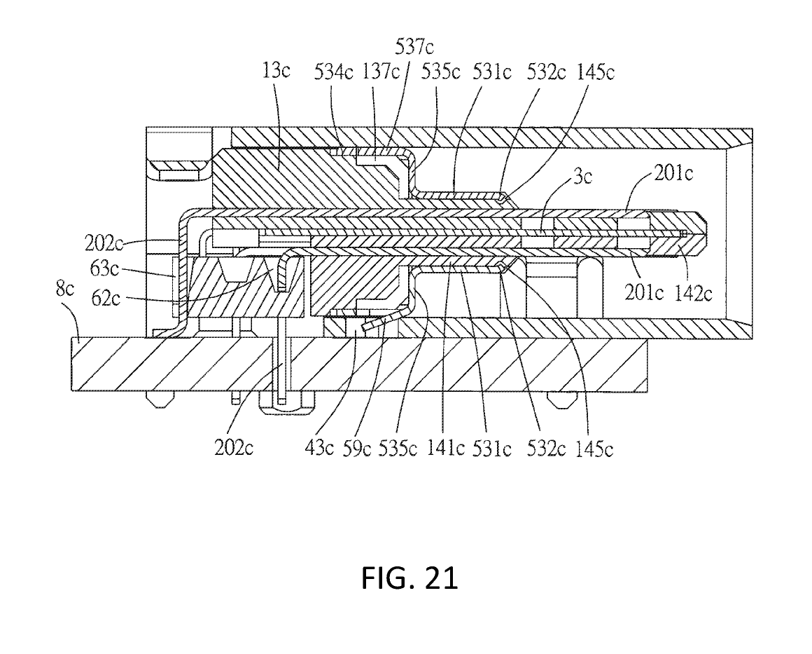

The insulative body 10c further has two channels 135c adjacent to two sides of the base portion 141c of the tongue 14c and extending vertically, a plurality of latch grooves 136c respectively formed on the upper surface 131c and the lower surface 132c, and two receiving recessed portions 137c formed on the upper surface 131c. In some equivalent embodiments, rear ends of the two channels are ended to the front of the main body 13c or a joint (not shown) between the main body 13c and the tongue 14c, the four fixed protruding tabs 536c are respectively formed on the two transversal sides of the two front extending plates 531c and are inserted and latch in the corresponding channel 135c, thereby achieving an object of fixing the two front extending plates 531c. Specifically, in the embodiment, the two channels 135c further extend rearwards into the main body 13c of the insulative body 10c with a predetermined depth, and vertically penetrate the main body 13c; rear portions of the four fixed protruding tabs 536c are inserted into the channels 135c formed on the main body 13c so as to be latched in the channels 135c by the main body 13c, thereby preventing the four fixed protruding tabs 536c from expanding outwards to deform; preferably, the four fixed protruding tabs 538c are respectively formed on the two transversal sides of the two rear extending plates 534c to insert and latch in the corresponding latch grooves 136c, so as to strengthen the fixing of the first metal plate 54c and the second metal plate 55c; the other two soldering legs 59c are formed on the connecting plate 535c and the rear extending plate 534c of the second metal plate 55c, each soldering leg 59c extends outwards from the front extending plate 531c toward the outer shielding shell 4c, the outer shielding shell 4c has two corresponding apertures 43c for receiving the corresponding soldering legs 59c, thereby making the soldering legs 59c corresponding to the apertures 43c soldered to the circuit board 8 (see FIG. 20, FIG. 21) so as to form a grounding effect and provide a fixing effect. The first metal plate 54c further has two connecting elastic tabs 537c formed on the connecting plate 535c and the rear extending plate 534c, the two connecting elastic tabs 537c extend outwards from the front extending plate 531c and contact the outer shielding shell 4c (see FIG. 21), thereby making the inner shielding shell 5c and the outer shielding shell 4c form a grounding and auxiliary fixing effect.

Preferably, a front edge of the inner shielding shell 5c has at least one arc guiding portion, the tongue 14c further has at least one receiving channel corresponding to the guiding portion, there is a gap between the front end edge of each guiding portion and each receiving channel, thereby making the guiding portion slightly displace into the receiving channel. Specifically, in the embodiment, the first metal plate 54c further has a guiding front edge 532c formed on the front edge of the front extending plate 531c and having an arc shape, the second metal plate 55c further has a guiding front edge 532c formed on the front edge of the front extending plate 531c and having an arc shape. The tongue 14c further has two receiving channels 145c (see FIG. 21) respectively formed on the upper surface 143c and the lower surface 144c of the base portion 141c, so as to respectively receive the two guiding front edges 532c. During the mating process of the mating connector 7c (see FIG. 10) and the electrical connector 300c, the two guiding front edges 532c may make the mating front edge 73c of the mating connector 7c easily pass through without retardancy. Also, after the mating connector 7c is mated with the electrical connector 300c, a plurality of upper grounding elastic tabs 71c and a plurality of lower grounding elastic tabs 71c of the mating connector 7c may contact and mate with the two front extending plates 531 of the inner shielding shell 5c to achieve a grounding effect, thereby forming a first grounding shielding configuration to prevent the electromagnetic radiation from passing through the insulative body 10c to leak rearwards. The outer shielding shell 4c contacts the shielding outer shell 72c of the mating connector 7c to form a second grounding shielding configuration, thereby effectively achieving an entire surrounding and shielding effect on the outer space of the mating cavity 41c.

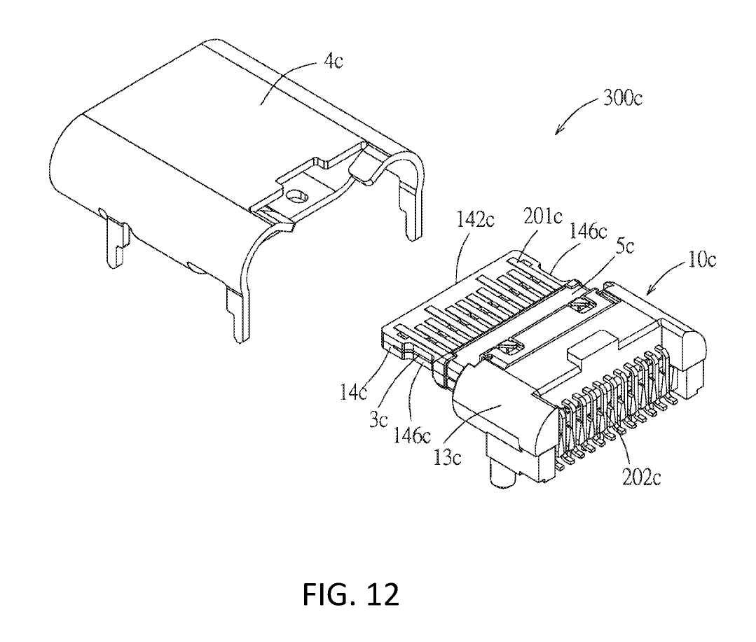

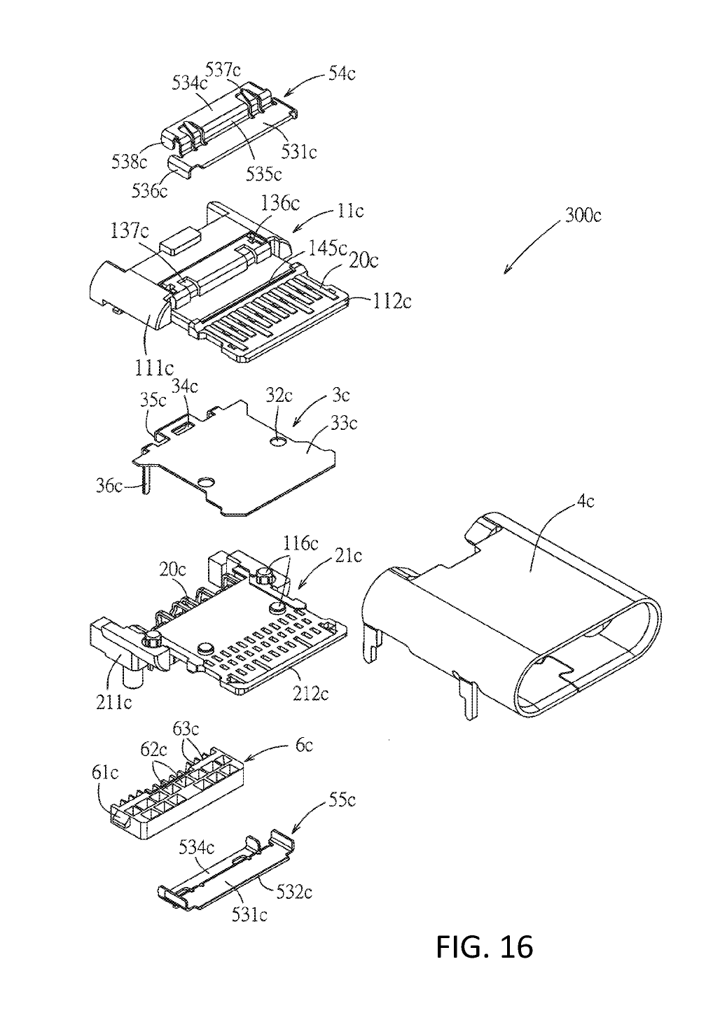

Referring to FIG. 16 to FIG. 19, the grounding metal plate 3c is interposed between the first insulative piece 11c and the second insulative piece 21c. The grounding metal plate 3c is a plate positioned between the terminals 20c in the upper row and the terminals 20c in the lower row, and comprises a first shielding portion 33c and a second shielding portion 35c extending from the first shielding portion 33c, and two grounding legs 36c respectively extending rearwards from the first shielding portion 33c and extending out of the insulative body 10c and positioned between the two sides of the second shielding portion 35c. The first shielding portion 33c is fixed in the insulative body 10c, the second shielding portion 35c and the tail portions 202c of the terminals 20c extend out of the insulative body 10c along a same direction. Specifically, the second shielding portion 35c is formed by being bent downwards from a rear end of the first shielding portion 33c of the grounding metal plate 3c and extending vertically, and extends between the tail portions 202c of the terminals 20c in the upper row and the tail portions 202c of the terminals 20c in the lower row along a transverse direction. In the embodiment, the second insulative piece 21c has a plurality of fixing protruding posts 116c, and the first insulative piece 11c has a plurality of fixing holes 117c respectively engaged with the fixing protruding posts 116c, the grounding metal plate 3c has a plurality of through holes 32c formed on the first shielding portion 33c for passing through of the corresponding fixing protruding posts 116c. Of course, in an equivalent embodiment, the first insulative piece 11c may have a plurality of fixing protruding posts, and the second insulative piece 21c may have a plurality of fixing holes. The grounding metal plate 3c may enhance the strength of the tongue 14c and decrease the high frequency crosstalk during the signal transmission between the terminals 20c in the upper row and the terminals 20c in the lower row, particularly, the second shielding portion 35c extends between the tail portions 202c of the terminals 20c in the upper row and the tail portions 202c of the terminals 20c in the lower row along a transverse direction, thereby further enhancing the shielding effect, and improving the electrical performance of the terminals 20c by the grounding of the grounding legs 36c. Furthermore, referring to FIG. 10 and FIG. 12, the tongue 14c further has two latching portions 146c respectively recessed from two sides of the extending portion 142c, parts of side edges of the grounding metal plate 3c are respectively exposed out of these latching portions 146c, therefore, latching elastic tabs (not shown) of the mating connector 7c may latch on to the corresponding latching portions 146c and contact the grounding metal plate 3c when the mating connector 7c and the electrical connector 300c are mated, and the mating connector 7c is grounded via the grounding legs 36c of the grounding metal plate 3c, a better grounding effect of the mating connector 7c is achieved.

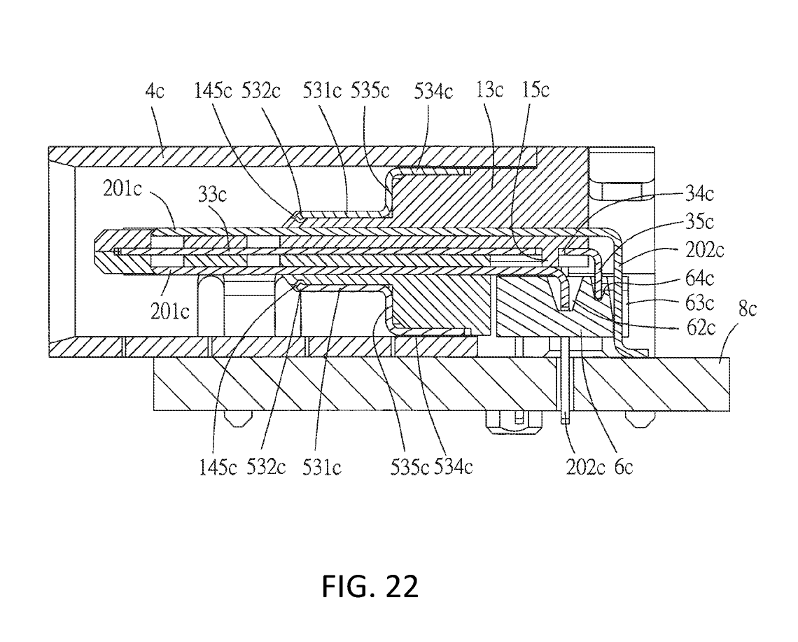

Referring to FIG. 18 to FIG. 21, the soldering leg positioning member 6c and the main body 13c of the insulative body 10c are engaged and fixed together. In particular, the soldering leg positioning member 6c is engaged with the rear side of the second insulative piece 21c and is positioned below the first insulative piece 11c, and has two latching blocks 61c respectively protruding from two sides of the soldering leg positioning member 6c so as to engage with limiting grooves 118c on the second insulative piece 21c, and a plurality of positioning holes 62c, 63c penetrating vertically for passing though and positioning of the tail portions 202c of the terminals 20c and the grounding legs 36c of the grounding metal plate 3c, thereby preventing the tail portions 202c and the grounding legs 36c from being deformed. In the embodiment, the tail portions 202c of the terminals 20c in the lower row extend straightly, vertically and downwards to form soldering legs which are used for via soldering. Ends of the tail portions 202c of the terminals 20c in the upper row are bent to form soldering legs which are used for surface soldering, and are positioned behind the tail portions 202c of the terminals 20c in the lower row, the positioning holes 63c of the soldering leg positioning member 6c in a rear row further penetrate a rear side surface of the soldering leg positioning member 6c for passing through of the tail portions 202c of the terminals 20c in the upper row. Moreover, the soldering leg positioning member 6c further has a positioning recessed portion 64c to correspondingly receive an end of the second shielding portion 35c of the grounding metal plate 3c (see FIG. 22), the positioning recessed portion 64c is positioned between the positioning holes 63c receiving the corresponding terminals 20c in the upper row and the positioning holes 62c receiving the corresponding terminals 20c in the lower row.

Referring to FIG. 19 and FIG. 22 to FIG. 24, the first insulative piece 11c protrudes further rearwards relative to the second insulative piece 21c, and a terminal spaced portion 15c protrudes from a bottom surface of the part of the first insulative piece 11c protruding further rearwards relative to the second insulative piece 21c. A rear portion of the grounding metal plate 3c is provided with an aperture 34c for passing through of the terminal spaced portion 15c. Referring to FIG. 22 to FIG. 24, the terminal spaced portion 15c abuts against the tail portions 202c of the two terminals 20c in the lower row positioned in the middle which protrude further rearwards relative to other terminals 20c, so as to prevent the tail portions 202c of the terminals 20c from being bent upwards and deformed to contact the grounding metal plate 3c to cause a short circuit when the tail portions 202c of the terminals 20c are mounted to the circuit board 8c.

In conclusion, the electrical connector 300c of the present disclosure enhances the strength of the tongue 14c and decreases the high frequency crosstalk during the signal transmission of the terminals 20c via the grounding metal plate 3c, and the second shielding portion 35c extends between the tail portions 202c of the terminals 20c in the upper row and the tail portions 202c of the terminals 20c in the lower row along a transverse direction, thereby further increasing the shielding effect, and achieving the object of improving the electrical performance and further increasing the grounding shielding effect. Moreover, the insulative body 10c is assembled by the first insulative piece 11c and the second insulative piece 21c, and then further assembled with the soldering leg positioning member 6c for passing through and positioning of the tail portions 202c of the terminals 20c and the grounding legs 36c of the grounding metal plate 3c, therefore the insulative component is assembled by three subcomponents, which is beneficial for the miniaturation of the electrical connector 300c and makes manufacture and assembling of the electrical connector 300c easier.

However, what have been described above are only embodiments of the present disclosure, the implementation scope of the present disclosure is not limited to that, that is, simple equivalent variations and modifications made according to the Claims and the description content of the present disclosure are still included in the protective scope of the present disclosure.

What is claimed is:

1. An electrical connector suitable to mate with another mating connector, the electrical connector comprising:
a combined body comprising:
a first terminal module having a first insulative piece and a plurality of first terminals fixed to the first insulative piece, the first insulative piece having a first base portion and a first tongue portion extending forwards from the first base portion, the first tongue portion having a first combined surface and a first mating surface opposite to each other, one end of each first terminal extending forwards from the first base portion to form a first mating portion exposed on the first mating surface, and the other end of each first terminal extending outwards from the first base portion to form a first soldering portion; and
a second terminal module having a second insulative piece assembled with the first insulative piece and a plurality of second terminals fixed to the second insulative piece, the second insulative piece having a second base portion and a second tongue portion extending forwards from the second base portion, the second tongue portion having a second combined surface facing the first combined surface and a second mating surface opposite to the second combined surface, one end of each second terminal extending forwards from the second base portion to form a second mating portion exposed on the second mating surface, the other end of each second terminal extending outwards from the second base portion to form a second soldering portion;
a grounding metal plate interposed between the first terminal module and the second terminal module; and
an outer shielding shell surrounding an outer space of the first tongue portion and an outer space of the second tongue portion and forming a mating cavity for insertion of the mating connector.

2. The electrical connector of claim 1, wherein the first insulative piece further has at least a first fixing mechanism on the surface facing the second insulative piece; the second insulative piece is provided with a second fixing mechanism cooperating with and fixed to the first fixing mechanism.

3. The electrical connector of claim 2, wherein the grounding metal plate is formed with at least a through hole corresponding to the first fixing mechanism and the second fixing mechanism; the first fixing mechanism and the second fixing mechanism are respectively a fixing protruding post and a fixing hole which cooperate with each other, the first fixing mechanism passes through the through hole of the grounding metal plate to engage with the second fixing mechanism.

4. The electrical connector of claim 1, wherein two opposite surfaces of the grounding metal plate respectively attach on the first combined surface of the first tongue portion and the second combined surface of the second tongue portion, the grounding metal plate is provided with two mating side edges respectively exposed out of the first tongue portion and the second tongue portion.

5. The electrical connector of claim 1, wherein a configuration of the first terminal module and a configuration of the second terminal module are the same, a fixed leg extend respectively from each of the first insulative piece and the second insulative piece.

6. The electrical connector of claim 1, wherein the first terminal module is provided above the second terminal module, at least a fixed leg extends downwards from the second base portion of the second insulative piece.

7. The electrical connector of claim 6, wherein the electrical connector further comprises a soldering leg positioning member fixed to the second terminal module; a plurality of soldering leg positioning holes are formed on the soldering leg positioning member for passing through and positioning the first soldering portions and the second soldering portions.

8. The electrical connector of claim 1, wherein the electrical connector further comprises an inner shielding shell provided to the combined body; the inner shielding shell is positioned between the outer shielding shell and the first base portion and the second base portion, and covers at least a rear section of the first tongue portion and the second tongue portion.

9. The electrical connector of claim 8, wherein the inner shielding shell comprises a fixed section and an extending section, the fixed section abuts against an inner surface of the outer shielding shell and is fixed to the first base portion or the second base portion, the extending section covers the rear section of the first tongue portion and the second tongue portion.

10. The electrical connector of claim 8, wherein the inner shielding shell comprises two metal plates respectively attaching on the first insulative piece and the second insulative piece; each metal plate has a front extending plate attaching on the rear section of the first tongue portion or the rear section of the second tongue portion, a rear extending plate attaching on the corresponding first base portion or the corresponding second base portion and a connecting plate perpendicular to the front extending plate and the rear extending plate.

11. The electrical connector of claim 10, wherein a front end of each front extending plate forms a guiding front edge; a gap is formed between each guiding front edge and each combined body to allow the guiding front edge slightly displace toward the combined body.

12. The electrical connector of claim 10, wherein two sides of the combined body are further formed with two receiving grooves respectively adjacent to the two sides of the front extending plate; a rear side of each receiving groove has a channel extending vertically and penetrating the first base portion and the second base portion; each metal plate further has two fixed protruding tabs provided at two sides of the corresponding front extending plate; each fixed protruding tab extends from the corresponding front extending plate and extends into the adjacent receiving groove and latches on to the corresponding channel.

13. The electrical connector of claim 10, wherein each metal plate further has at least a connecting elastic tab extending away from the combined body; each connecting elastic tab is engaged with the outer shielding shell.

14. An electrical connector suitable to mate with another mating connector, the electrical connector comprising:
a combined body comprising: an insulative body having a main body and a tongue protruding forwards from the main body, the tongue having an upper surface and a lower surface; and a plurality of terminals divided into an upper row and a lower row and fixed to the insulative body, each terminal comprising a contact portion extending forwards and exposed out of the tongue and a tail portion extending out of the insulative body, the contact portions of the terminals in the upper row being exposed on the upper surface of the tongue and the contact portions of the terminals in the lower row being exposed on the lower surface of the tongue;
a grounding metal plate fixed in the combined body and being a plate positioned between the terminals in the upper row and the terminals in the lower row;
an outer shielding shell combined with the insulative body and surrounding an outer space of the tongue to define a mating cavity; and
an inner shielding shell positioned in an inner side of the outer shielding shell and provided on a surface of the combined body, the inner shielding shell comprising an upper metal plate and a lower metal plate, the upper metal plate having at least a connecting elastic tab extending away from the combined body, the connecting elastic tab being connected to the outer shielding shell.

15. The electrical connector of claim 14, wherein the lower metal plate has at least a connecting elastic tab extending away from the combined body, the connecting elastic tab is connected to the outer shielding shell.

16. The electrical connector of claim 14, wherein the lower metal plate has at least a soldering leg extending away from the combined body, the soldering leg extends out of the outer shielding shell and is soldered to the corresponding circuit board for achieving grounding.

17. The electrical connector of claim 14, wherein the grounding metal plate comprises a first shielding portion and a second shielding portion extending from the first shielding portion, the first shielding portion is fixed in the insulative body, the second shielding portion and the tail portions of the terminals extend out of the insulative body along the same direction.

18. The electrical connector of claim 14, wherein the outer shielding shell has at least a soldering leg to be soldered to the circuit board for achieving grounding.

19. The electrical connector of claim 14, wherein the insulative body is assembled by a first insulative piece and a second insulative piece, the terminals in the upper row are embedded in the first insulative piece, the terminals in the lower row are embedded in the second insulative piece, the grounding metal plate is interposed between the first insulative piece and the second insulative piece.

20. The electrical connector of claim 19, wherein the first insulative piece comprises a first base portion and a first tongue portion extending forwards from the first base portion, the contact portions of the terminals in the upper row are exposed out of the first tongue portion; the second insulative piece comprises a second base portion and a second tongue portion extending forwards from the second base portion, the contact portions of the terminals in the lower row are exposed out of the second tongue portion; the first tongue portion and the second tongue portion are assembled to form the tongue of the insulative body, the first base portion and the second base portion are assembled to form the main body of the insulative body.
